(19) United States
(12) Patent Application Publication
(10) Pub. No.: US 2012/0142469 A1
(43) Pub. Date: Jun. 7, 2012

(54) DUAL PULLEY CHAIN GUIDE AND GUARD

(75) Inventors: Darek C. Barefoot, Grand Junction, CO (US); Ryan K. Cranston, Grand Junction, CO (US)

(73) Assignee: Eko Sport, Inc., Grand Junction, CO (US)

(21) Appl. No.: 13/309,740

(22) Filed: Dec. 2, 2011

Related U.S. Application Data
(60) Provisional application No. 61/418,924, filed on Dec. 2, 2010.

(51) Int. Cl. B62M 9/00; F16H 7/20

(52) U.S. Cl. 474/139

(57) ABSTRACT

A chain guide having a mounting bracket mounted to the bottom bracket shell with multiple coaxial pulleys, each of which is in substantially planar alignment with one chainring of a crank with two or more chainrings. Each pulley cog engages the bicycle chain when the chain is on a corresponding chainring. One of the pulley cogs can be replaced by a roller mounted to the bracket coaxially with the first pulley cog and in substantially planar alignment with the corresponding chainring.

### CROSS-REFERENCES TO RELATED APPLICATIONS

This application claims the benefit of U.S. Provisional Application No. 61/418,924 filed Dec. 2, 2010. This prior application is hereby incorporated by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

This invention relates generally to devices for maintaining the drive chain safely on the teeth of the chainrings of a bicycle. More specifically, the invention relates to structures for tensioning the drive chain by pulleys or pulleys in combination with non-toothed rollers aligned with two or more chainrings of a bicycle crankset.

It has long proved advantageous to have multiple gears on a bicycle drivetrain, and in bicycle vernacular a “gear” is commonly referred to as a particular “sprocket” or “cog” or a combination of the two when mated together by a drive chain. In a typical multiple-sprocket drivetrain, a sprocket cluster or cogset is rotatably mounted to the axle of the rear wheel. A sprocket cluster or cogset is a grouping of multiple sprockets that are coaxially aligned and attached together. While the bicycle is being ridden, the rider moves the drive chain between the different cogs on the cogset through a typically cable-actuated derailleur affixed to the rear extremity of the bicycle frame. In the case of a single sprocket at the crank and around which the front of the drive chain extends, the number of gears available to the rider is equal to the number of cogs on the cogset.

The range of gears available to the rider is increased by combining the rear wheel cogset with multiple sprockets or “chainrings” rotatably mounted to the bicycle crank. As with the cogset at the rear wheel, the rider moves the drive chain from one chainring to another at the front of the drive chain by means of a cable-actuated derailleur affixed to the lower center portion of the bicycle frame, near the bottom bracket bearing set. In the multiple chainring and cogset drivetrain, the number of gears available to the rider is equal to the number of unique combinations of the chainrings and the cogs.

To achieve a range of gearing wide enough for demanding terrain, such as that encountered in mountain biking, the sizes of sprockets of the rear cogset can vary by more than 30 sprocket teeth from the smallest cog to the largest. Furthermore, the sizes of sprockets on the chainrings can vary by more than 20 sprocket teeth. The drive chain must be long enough to extend simultaneously around the largest gear of the chainring and the largest gear on the cogset, and must also be adapted to extend around the smallest gears at the chainring and the cogset. The large variance in effective chain length required by different combinations of chainrings and rear cogs leaves considerable chain slack in some gears. To reel up this slack, the rear derailleur typically has a spring-loaded arm with two non-coaxial, inline pulleys that share a common plane of rotation, through which the chain is threaded and which apply biasing force to contract the chain when the effective chain length required is relatively short. The derailleur pulleys have low profile teeth that are sufficiently engaged with the chain to derail it inboard or outboard from one cog to the next or to maintain good alignment and therefore positive engagement with the driving cog. Thus, a derailleur-style pulley is a toothed cog with low-profile teeth.

Due to the direction the cranks are rotated to drive the chainring, the top span of chain in the drive chain loop drives the cogset. The rear derailleur is located near the cogset at the rear wheel behind the bulk of the lower, non-driving course of the chain that extends back from the underside of the driving chainring. The tensioning force of the rear derailleur torsion spring on the lower course of chain is not enough to prevent bumps encountered at speed from shaking this lower course of chain violently. This uncontrolled chain movement can, under some circumstances, cause or contribute to unwanted derailment of the chain from the driving chainring. Undesired disengagement of the chain is most likely to occur where the choice of cogs and chainrings requires a relatively long chain and where terrain is rugged, both of which are conditions typical of off-road cycling.

Preventing unwanted derailment of the chain from the crank is easiest when the bicycle crankset uses only one chainring, and is commonly accomplished with devices that supplement the tensioning force of the rear derailleur. Appliances are commonly affixed to the bottom bracket or elsewhere on the bicycle frame to provide a post, roller, slide, or derailleur-style pulley behind the chainring and above or below a straight line that extends from the top of the chainring to the rear cogset or from the bottom of the chainring to the lower pulley of the rear derailleur. Most commonly the lower course of the chain is routed up and over the post, roller, slide or derailleur-style pulley so that the chain wraps around a greater portion of the chainring than it otherwise would. This configuration insulates the interface between chain and chainring from even violent shaking of the bicycle. Such tensioners are sometimes incorporated into chain guides that have other features to protect the chainring and prevent derailment of the chain (e.g., U.S. Pat. No. 5,725,450 to Huskey).

Preventing derailment from a crank with multiple chainrings, as opposed to a single chainring, is mechanically more challenging. Chain tensioning devices for use with two or more chainrings are typically variants of two designs. In one of these designs, a bracket affixed to the bicycle frame supports a rotatably mounted roller, which is located behind the crank and relatively closer to the crank than to the rear cogset and over which the lower course of the chain is routed. A device of this kind, marketed under the brand name MRP with the product name “LRP Chainguide,” has been produced for many years by Mountain Racing Products of Grand Junction, Colo. The roller of this product is made of urethane with a smooth surface and sufficient width in the inboard/outboard direction to allow the chain to be shifted between two front chainrings. The roller surface of such a device may be simply cylindrical and of a single diameter. Alternatively, it may be “stepped” with two or more diameters, so that when the rider shifts the chain onto a chainring with fewer teeth, the chain ideally moves onto a larger diameter of the roller, thereby increasing tension to at least partially offset the increased chain slack. In yet another variation, the roller has a conical profile in which the effective diameter continuously varies inversely to the direction in which chainrings increase in size (see U.S. Pat. No. 7,059,983 to Heim).

The roller of the aforesaid device is commonly of a slightly elastic material such as urethane, both to minimize noise and to provide some traction between the roller and chain. Because the roller is circumferentially smooth, lacking projections that positively engage with the chain, its use entails a compromise between precise alignment of the chain with the driving chainring (i.e., resistance to inboard-outboard drift of the chain) and allowance for free inboard-outboard movement of the chain during shifting. Where the roller has a stepped profile to vary chain tension advantageously, the chain may hesitate to “climb” onto the larger diameter of the roller and, conversely, may tend to drop to the smaller diameter prematurely, before the chain has completed a shift from a smaller to a larger chainring. Although the chance of such hesitation is lessened with the conical profile roller, because the tapered surface of such a roller does not support the chain evenly, the roller applies a slight twisting bias to the chain that compromises good alignment.

In the second kind of tensioning device for use with multiple chainrings, the roller is grooved and rotates on a post which is wider than the roller and along which the roller is free to slide axially inboard or outboard by a dimension comparable to the total of the distances between the chainrings. This device does not provide greater chain tensioning for the smaller chainring(s) as compared with the larger one(s), but insofar as the roller floats axially it might be expected to maintain alignment with the driving chainring better than rollers that are axially confined. In practice, however, since the biasing force created by the shift to a different chainring operates at a significant distance from the roller, even minor resistance to the sliding of the roller along the post will leave the lower course of the chain poorly aligned with the driving chainring. A splash of mud on the post, for example, can impede the axial sliding of the roller and consequently prevent realignment of the chain.

Since misalignment of either the upper or lower course of the chain can contribute to derailment, to the extent that the above-described devices for multiple chainrings fail to align the lower course of the chain with the driving chainring precisely and consistently, they fall short of their design goal. Moreover, a chain tensioning device should provide for consistently good alignment not just to prevent outright derailment but in order to prevent noise, allow front shifting without excessive friction, and minimize friction-related wear of drivetrain components.

The need therefore exists for a device for use with multiple chainrings that applies tension to the chain to prevent unwanted derailment while precisely and consistently aligning the lower course of the chain with the driving chainring. Other novel advantages of the device will become apparent in the following specification.

### BRIEF SUMMARY OF THE INVENTION

A mounting bracket is preferably affixed to the bottom bracket shell of the bicycle. Affixed to the bracket are multiple coaxial derailleur-style pulleys, or a single pulley with two or more coaxial, toothed cogs, each of which is in substantially planar alignment with one chainring of a crank with two or more chainrings. The teeth of a particular pulley cog engage the bicycle chain when the chain is on the corresponding chainring, which is the chainring most closely aligned with that pulley cog. In another embodiment, one or more pulley cogs and one or more rollers are coaxially affixed to the bracket, and the pulley cogs and rollers are in substantial planar alignment with the chainrings of the crank. The teeth of a particular pulley cog engage the bicycle chain when the chain is on the chainring most closely aligned with that pulley cog, and the chain rides on the surface of a particular roller when the chain is on the chainring most closely aligned with that roller.

### BRIEF DESCRIPTION OF THE SEVERAL VIEWS OF THE DRAWINGS

FIG. 1 is a side view illustrating a bicycle frame showing portions of the downtube, seat tube, right chainstay, and bottom bracket shell with integral bosses for chain guide attachment.

FIG. 2 is a side view illustrating a first embodiment of the present invention attached to the bosses of the bottom bracket shell.

FIG. 3 is a side view illustrating the attachment of the pulley assembly to the projecting arm of the bracket.

FIG. 4 is a side view illustrating the embodiment of FIG. 1 assembled to a frame with crank, chainrings, and chain.

FIG. 5 is a side view illustrating another embodiment of the present invention wherein the bracket supports a chain guard that can be integral with the bracket or removably mounted thereto.

FIG. 6 is a side view illustrating the embodiment of FIG. 5 and further incorporating a chain guard with crank, chainrings, and chain in an operable configuration.

FIG. 6a is a rear view illustrating the embodiment of FIG. 6.

FIG. 7 is a top view in section illustrating the embodiment of FIG. 5.

FIG. 7A is a top view in section illustrating the detail of FIG. 7.

FIG. 8 is a side view of another embodiment of the present invention wherein both a pulley cog and a roller are mounted to the arm of the bracket.

FIG. 9 is a top view in section illustrating the embodiment of FIG. 8.

FIG. 9A is a top view in section illustrating the detail of FIG. 9.

FIG. 10 is a side view illustrating another embodiment of the present invention incorporating a protective ring attached to the crank.

FIG. 11 is a top view in section illustrating the embodiment of FIG. 10.

FIG. 11A is a top view in section illustrating the detail of FIG. 11.

FIG. 12 shows a side view illustrating another embodiment of the present invention with a non-rotatable guide outboard of the pulley assembly.

FIG. 13 is a top view illustrating the embodiment of FIG. 12.

FIG. 13A is a top view in section illustrating the detail of FIG. 13.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

Patent application Ser. No. 61/418,924 filed Dec. 2, 2010 is incorporated herein by reference.

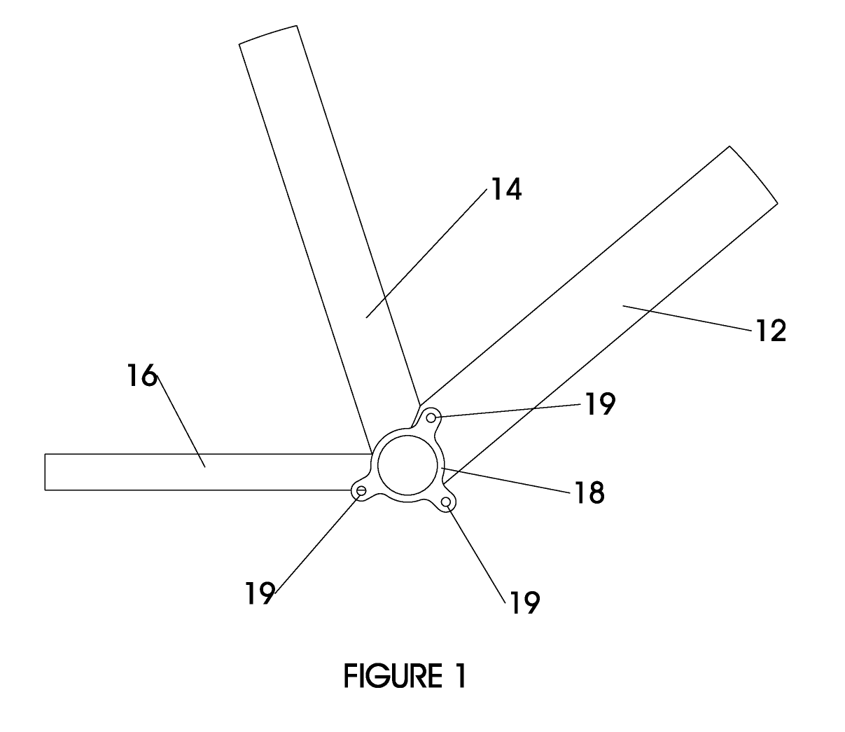

Referring to FIG. 1, the portion of the bicycle frame 10 that is shown consists of the down tube 12, seat tube 14, chain stays 16, and bottom bracket shell 18. The bottom bracket shell 18 further incorporates mounting bosses 19 for chain guide attachment. The mounting bosses 19 can be compliant with ISCG (International Standard Chain Guide) standards (see www.iscg.org). The extreme forward and rear portions of the frame, consisting of the points of front and rear wheel attachment, are not shown. Furthermore, the extreme upper portions of the frame, to which the seat and handlebars are attached, are not shown.

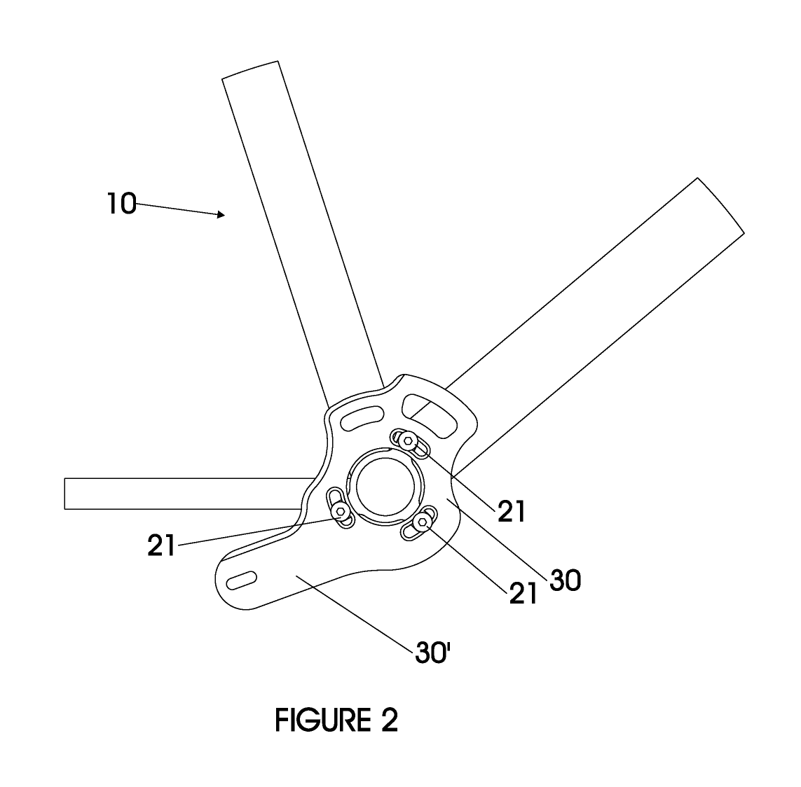

Referring to FIG. 2, the bracket 30 of the invention is attached to the frame 10 at the bottom bracket shell bosses 19 (not visible) with the screws 21. The bracket 30 is a substantially planar plate, which can be made of aluminum, polycarbonate or any other suitable material, that is rigid and light enough to accomplish the purposes that are described below.

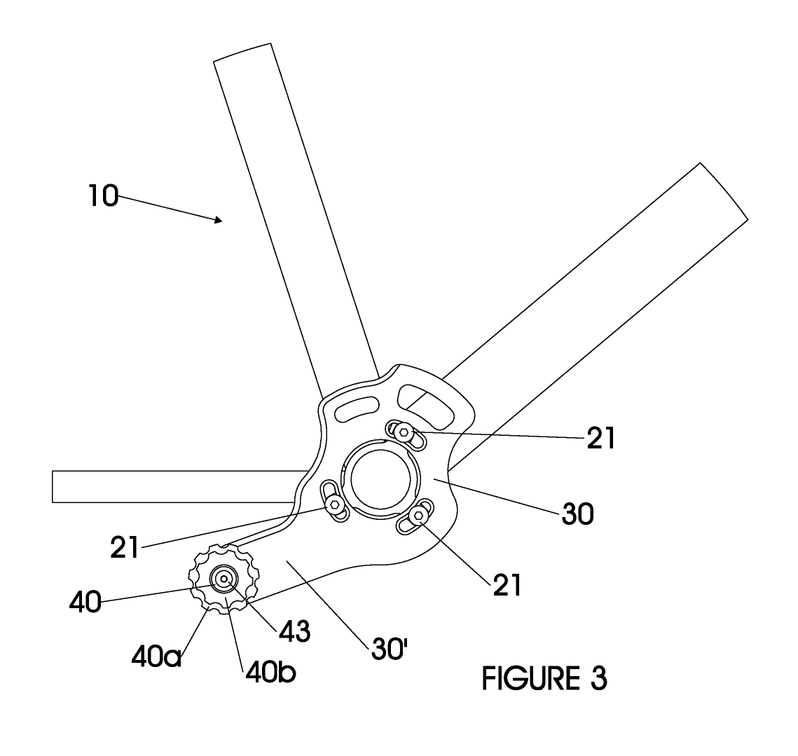

Referring to FIG. 3, the rotatable pulley assembly 40 is attached to the arm of the bracket 30 with the screw 43. The screw 43 is preferably extended through the slot in the extension arm 30′ of the bracket 30 (see FIG. 2), and tightened against internal component of the bearing that is mounted in the assembly 40. Thus, the screw and the internal component of the bearing remain stationary with the bracket 30, and the external component and cogs 40a and 40b are substantially free to rotate relative to the bracket 30.

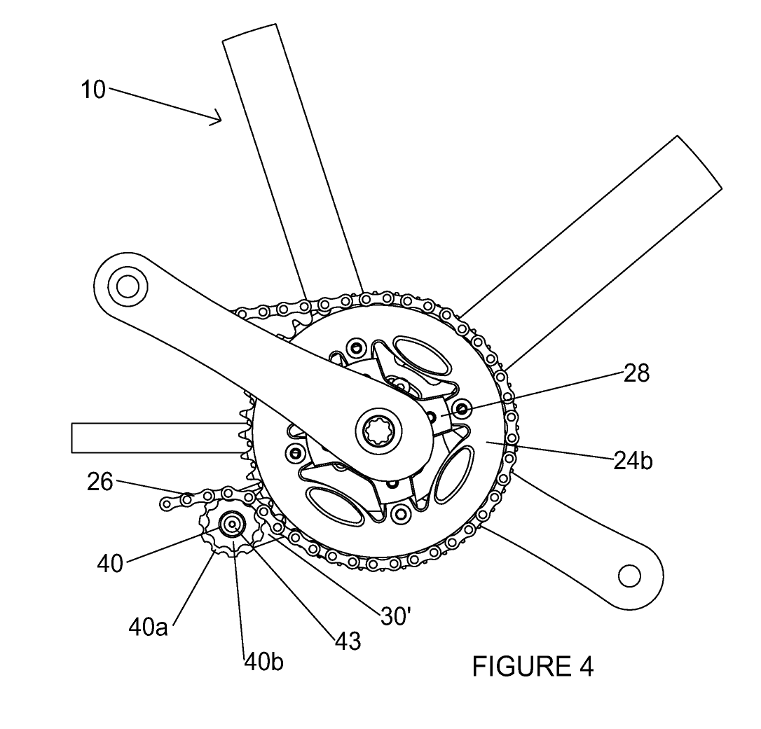

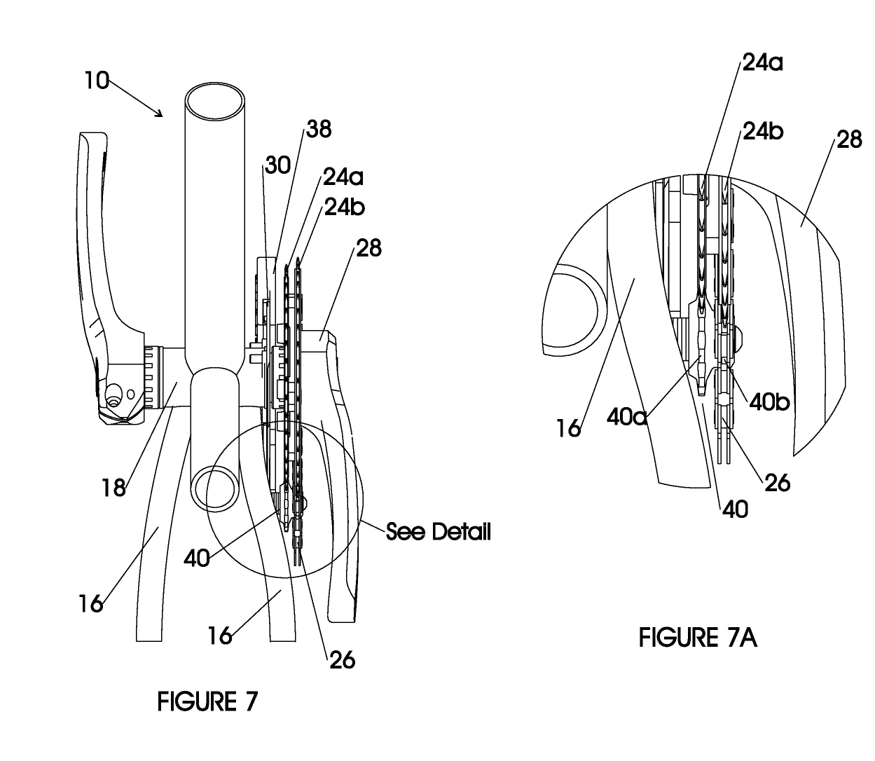

Referring to FIGS. 4 and 7a, the pulley assembly 40 is positioned just behind the chainrings of the crank 28. The cogs 40a and 40b are aligned substantially with the chainrings mounted to the crank. The first pulley cog 40a is rotatably mounted to the projecting arm 30′ and has a central rotational plane aligned with a central rotational plane of one of the chainrings 24a. The second pulley cog 40b is rotatably mounted to the projecting arm 30′ and is coaxial with the first pulley cog 40a. The second pulley cog 40b has a central rotational plane that is substantially aligned with the central rotational plane of the second chainring 24b.

The chain 26 is routed over the assembly 40 so that the length of engagement of the chain with the chainring is optimized, and so that the chain 26 engages one of the cogs 40a and 40b that corresponds to the chainring the chain engages.

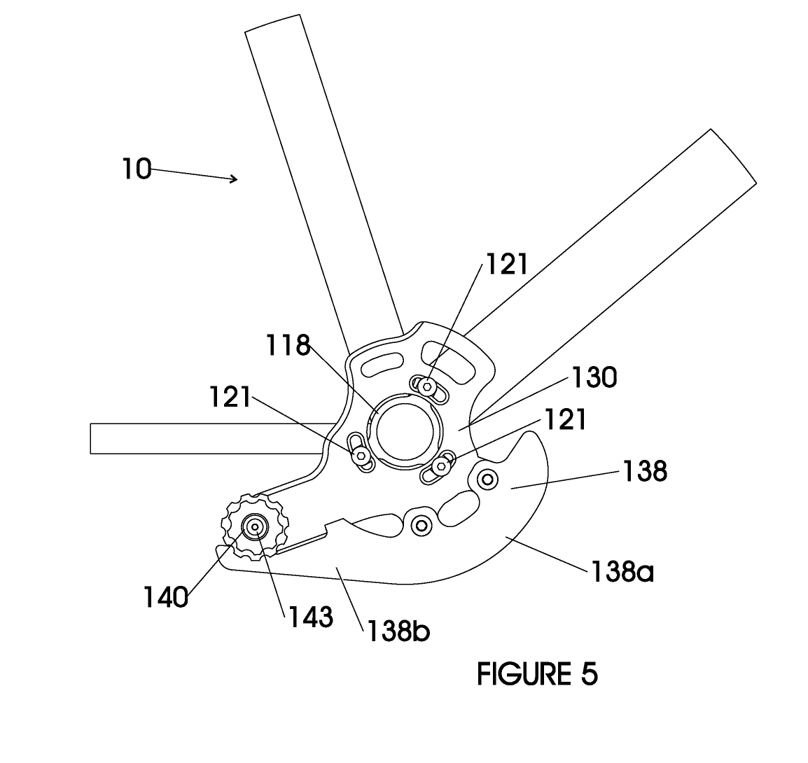

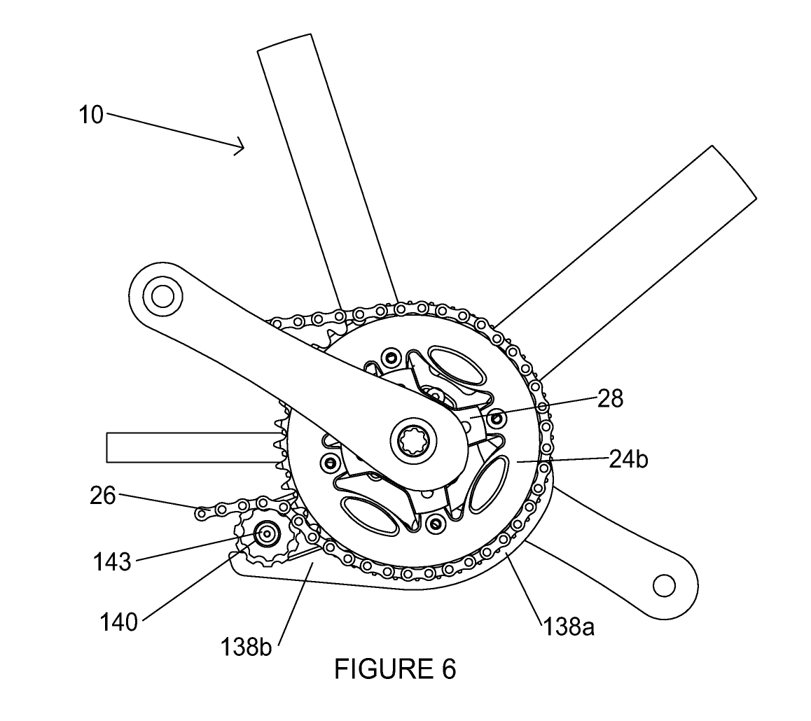

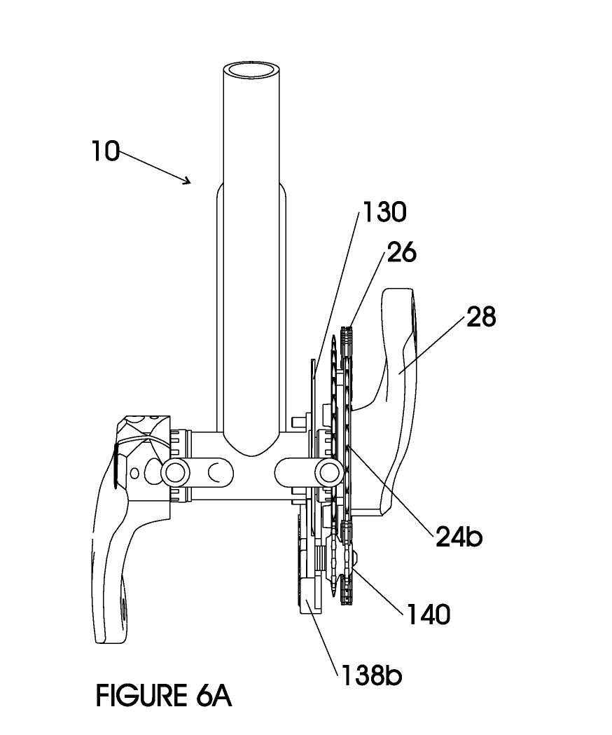

Referring to FIGS. 5, 6 and 6a, which show a bracket 130 that is substantially identical to the bracket 30 of FIG. 3 but incorporates a guard 138 that is intended to protect the chainrings 24a and 24b from underside impacts. The guard 138 preferably has an arcuate, semi-circumferential portion 138a that aligns with the outer edge of the largest chainring and is positioned relatively below and forward of the bottom bracket shell 118 of the frame. The guard 138 can be integral with the bracket 130, it can be removably mounted to the bracket or the portion 138a can be removably mounted to the bracket 130. In order to provide maximum convenience to the bicycle rider, it is preferred that the guard 138 and/or the portion 138a can be removed from the mounting bracket 130 and a replacement mounted to the mounting bracket 130 without removing the mounting bracket 130 from the bicycle frame. This application incorporates by reference the structures disclosed in U.S. Pat. No. RE42,436 and my co-pending U.S. patent application Ser. No. 12/201,627 filed Aug. 29, 2008.

Referring to FIGS. 6 and 6a, the semi-circumferential portion of the guard 138a can be seen to extend radially beyond the largest chainring 24b, thereby affording protection of the chainrings from underside impacts. The guard 138 strikes an obstruction that the bicycle is riding over rather than the obstruction striking the chainrings 24a and 24b, and the guard 138 transmits the force of impact through the mounting bracket 130 to the bicycle frame. The guard 138 also has a rearward extension 138b so as to protect the pulley assembly 140 from underside impacts in a similar manner. The guard 138 and rearward extension 138b preferably have widths that are sufficient to provide this protection, but do not extend into the planes of the chainrings 24a and 24b. That is, the preferred guard 138 and rearward extension 138b are inboard of both chain rings.

Referring to FIGS. 7 and 7A, the respective cogs 40a and 40b of the pulley assembly 40 are substantially aligned with the corresponding chainrings 24a and 24b, respectively, of the crank 28. Thus, when either chainring is driving the chain 26, the chain is positively engaged with one of the cogs 40a and 40b of the pulley assembly. It should be noted that in FIGS. 7 and 7A and in other top views the upper course of the chain has been omitted so that the lower course of the chain can be seen more clearly.

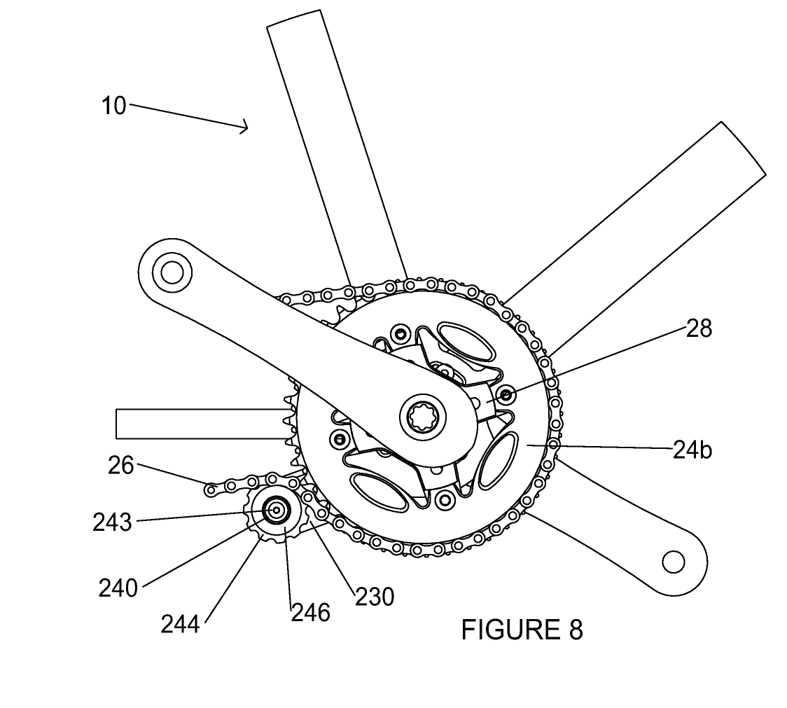

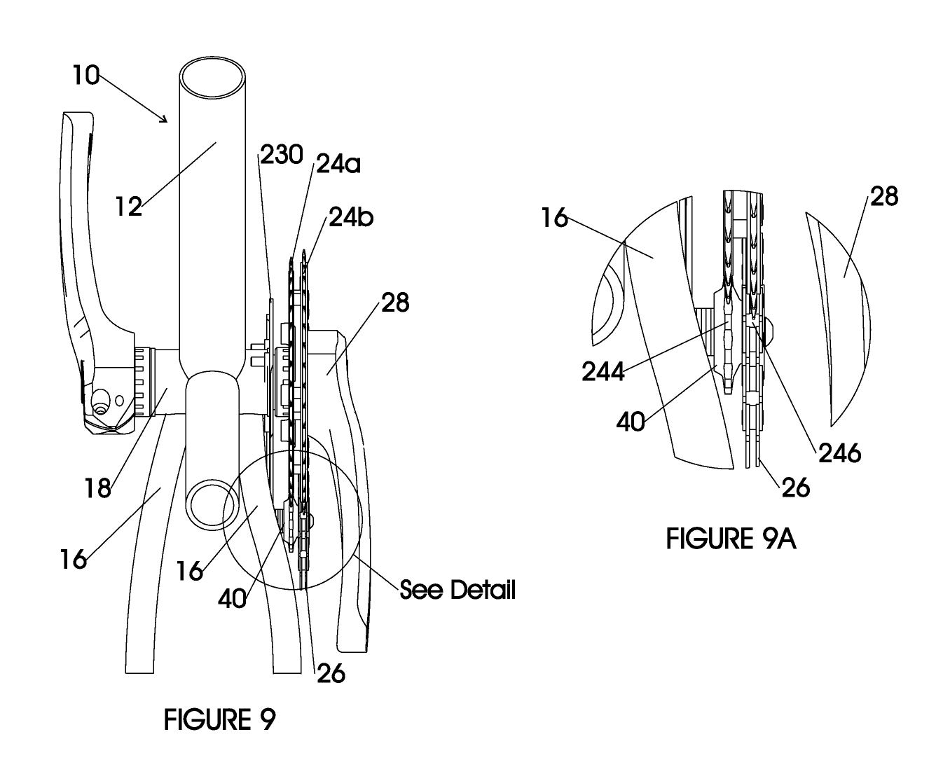

Referring to FIGS. 8, 9, and 9A, the roller 246, which is coaxial with the pulley cog 244, is attached to the bracket 30. As with the previously described embodiments, the roller 246 and cog 244 are rotatably mounted to substantially freely rotate about the axis of the screw 243 that mounts the entire assembly to the bracket 230.

Referring specifically to FIGS. 9 and 9A, each of the roller 246 and pulley cog 244 is aligned with a corresponding one of the chainrings, so that when one of the chainrings is driving the chain 26, the chain is engaged by one or the other of the pulley cog and the roller. This provides similar support to the chain in an alternative arrangement to those embodiments described above.

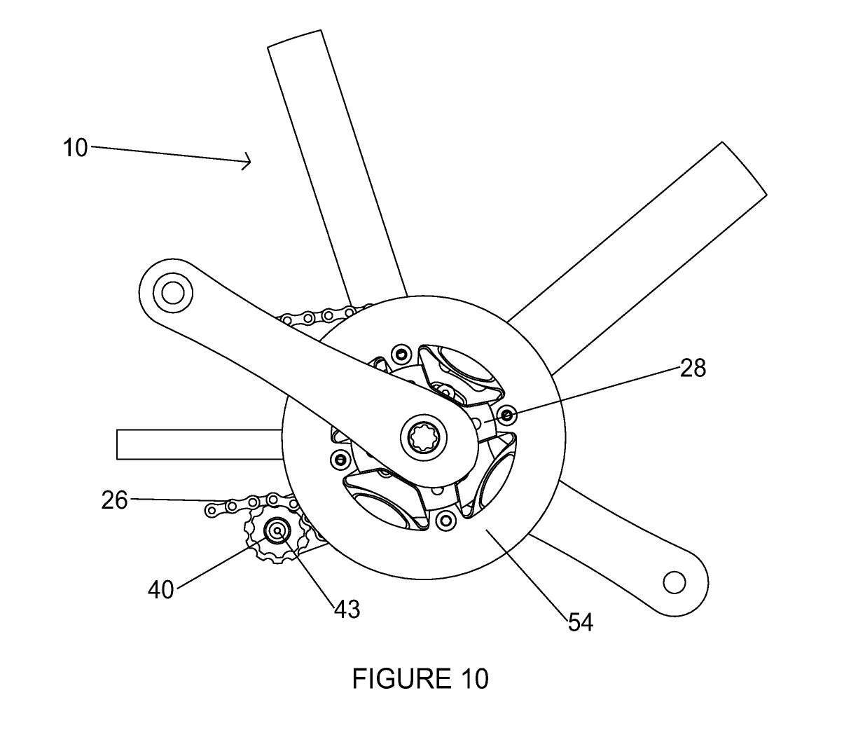

Referring now to FIG. 10, the invention of FIG. 1 is shown in combination with a protective ring 54 that is mounted to the crank 28. The diameter of the ring 54 is large enough to have an outer edge that extends beyond the radially outermost edge of the chainrings to protect the largest of the chainring 24b (not visible) from inadvertent impacts, and to protect the smaller chainring.

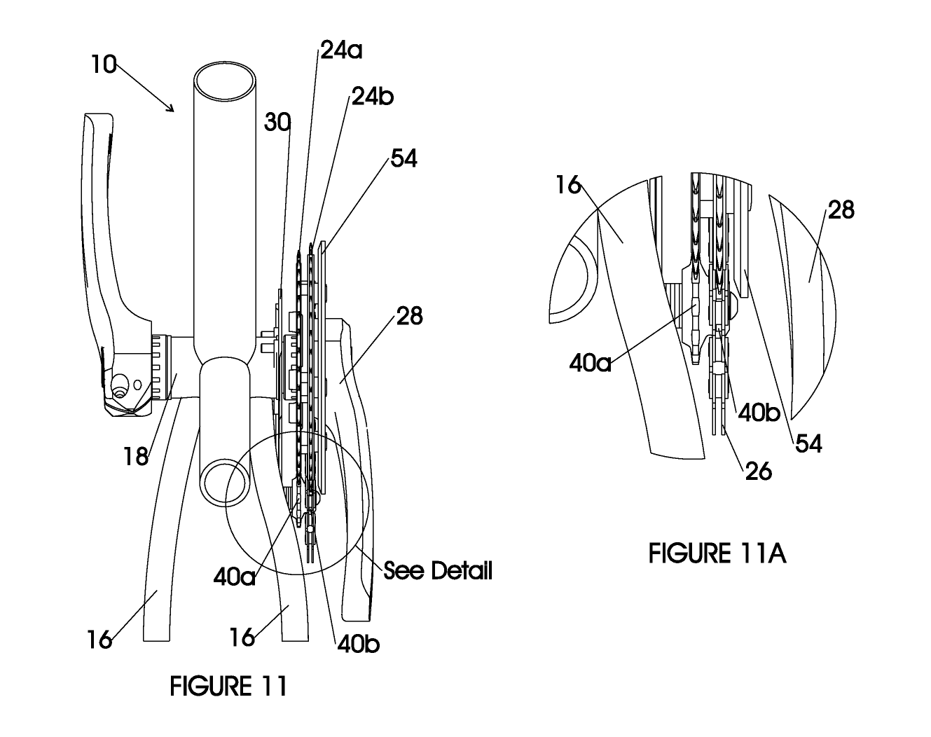

Referring to FIGS. 11 and 11A, the alignment of the pulley cogs 40a and 40b with the chainrings can be seen. The protective ring 54 is positioned outboard a sufficient distance to allow for chain engagement with the outermost chainring 24b, but close enough to the outermost chainring to prevent the chain 26 from slipping off the cog 40b in the outboard direction.

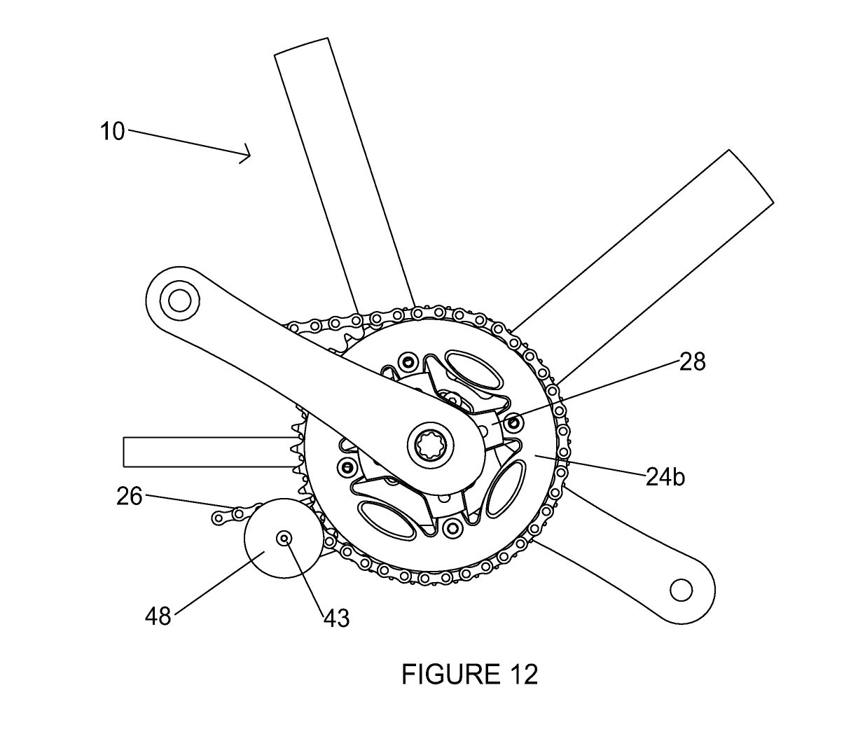

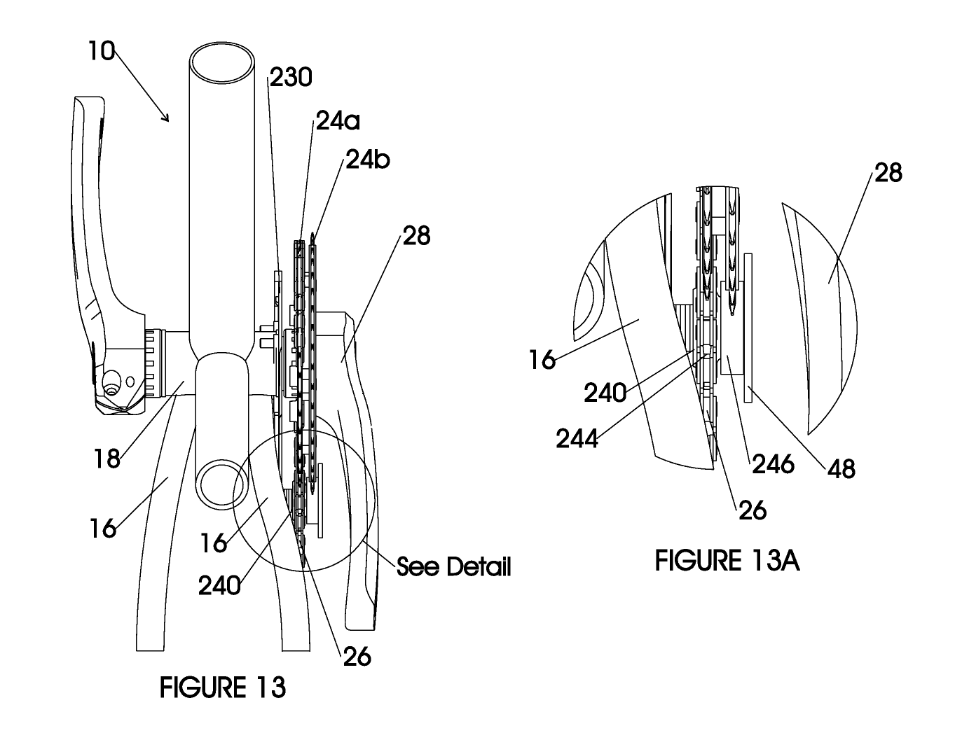

Referring to FIG. 12, the invention of FIG. 8 is shown with a non-rotatable guide 48 attached outboard of the pulley assembly 40 (see FIGS. 13 and 13A). In FIGS. 13 and 13A, the non-rotatable guide 48 is aligned substantially parallel to, and outboard of, the rotational planes of the pulley cog 244 and roller 246, and close enough to the roller to prevent the chain from slipping off the roller in the outboard direction.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A bicycle chain guide for a bicycle having a crankset with at least a first and a second chainring, the chain guide comprising:
(a) a mounting bracket secured to the bicycle frame, the mounting bracket having a projecting arm;
(b) a first pulley cog rotatably mounted to the projecting arm, the first pulley cog having a central rotational plane substantially aligned with a central rotational plane of the first chainring; and
(c) a second pulley cog rotatably mounted to the projecting arm, the second pulley cog being coaxial with the first pulley cog and having a central rotational plane substantially aligned with the central rotational plane of the second chainring.

2. The bicycle chain guide in accordance with claim 1, wherein the mounting bracket further comprises a guard substantially concentrically aligned with the chainrings and extending radially below the largest chainring to protect the chainrings from inadvertent impacts.

3. The bicycle chain guide in accordance with claim 1, further comprising a protective ring secured to the crankset, the protective ring having an outer edge that extends beyond an outer edge of said chainrings.

4. The bicycle chain guide in accordance with claim 1, further comprising a guide disposed outboard of the pulley cogs to prevent derailment of the chain from an outermost of the pulley cogs in an outboard direction.

5. The bicycle chain guide in accordance with claim 1, wherein the mounting bracket defines a plurality of mounting holes and wherein the mounting bracket is secured adjacent to a bottom bracket shell of the bicycle frame.

6. The bicycle chain guide in accordance with claim 2, wherein said guard is removably mounted to the mounting bracket.

7. The bicycle chain guide in accordance with claim 6, wherein said guard is mounted to said mounting bracket by fasteners selected from bolts, screws, and a bolt-and-nut combination.

8. The bicycle chain guide in accordance with claim 6, wherein said guard is configured for removal and replacement without removing the mounting bracket from the frame.

9. The bicycle chain guard in accordance with claim 2, wherein said guard extends rearward to below said pulley cogs so as to protect said pulley cogs from inadvertent impacts.

10. The bicycle chain guide in accordance with claim 1, wherein said mounting bracket is secured to at least one threaded boss on a bottom bracket shell of the bicycle frame.

11. The bicycle chain guide in accordance with claim 10, wherein said at least one threaded boss comprises a plurality of threaded bosses spaced around the bottom bracket shell.

12. The bicycle chain guide in accordance with claim 1, further comprising arcuate mounting slots on said mounting bracket, the slots aligning substantially with at least one threaded boss on a bottom bracket shell of the bicycle frame.

13. The bicycle chain guide in accordance with claim 12, wherein said at least one threaded boss comprises a plurality of threaded bosses spaced around the bottom bracket shell.

14. The bicycle chain guide in accordance with claim 3, further comprising a guide affixed outboard of the pulley cogs to prevent derailment of the chain from an outermost of the pulley cogs in an outboard direction.

15. The bicycle chain guide in accordance with claim 2, further comprising a protective ring secured to the crankset, the protective ring having an outer edge that extends beyond an outer edge of said chainrings

16. The bicycle chain guide in accordance with claim 2, further comprising a guide affixed outboard of an outermost of the pulley cogs to prevent derailment of the chain from an outermost of the pulley cogs in an outboard direction.

17. The bicycle chain guide in accordance with claim 15, further comprising a guide affixed outboard of an outermost of the pulley cogs to prevent derailment of the chain from an outermost of the pulley cogs in an outboard direction.

18. A bicycle chain guide for a bicycle having a crankset with at least a first and a second chainring, the chain guide comprising:
(a) a mounting bracket adapted to be secured to the bicycle frame, the mounting bracket having a projecting arm;
(b) a first pulley cog rotatably mounted to the projecting arm, the first pulley cog having a central rotational plane configured for substantial alignnment with the central rotational plane of the first chainring; and
(c) a second pulley cog rotatably mounted to the projecting arm, the second pulley cog being coaxial with the first pulley cog and having a central rotational plane configured for substantial alignment with the central rotational plane of the second chainring.

19. A bicycle chain guide for a bicycle having a crankset with at least a first and a second chainring, the chain guide comprising:
(a) a mounting bracket secured to the bicycle frame, the mounting bracket having a projecting arm;
(b) a pulley cog rotatably mounted to the projecting arm, the pulley cog having a central rotational plane substantially aligned with a central rotational plane of the first chainring; and
(c) a roller rotatably mounted to the projecting arm, the roller being coaxial with the pulley cog and having a central rotational plane substantially aligned with the central rotational plane of the second chainring.

20. The bicycle chain guide in accordance with claim 19, wherein the mounting bracket further comprises a guard substantially concentrically aligned with the chainrings and extending radially below the largest chainring to protect the chainrings from inadvertent impacts.

21. The bicycle chain guide in accordance with claim 19, further comprising a protective ring secured to the crankset, the protective ring having an outer edge that extends beyond an outer edge of said chainrings.

22. The bicycle chain guide in accordance with claim 19, further comprising a guide disposed outboard of the pulley cog and roller to prevent derailment of the chain from an outermost of the pulley cog and roller in an outboard direction.
